(19) United States
(12) Patent Application Publication
(10) Pub. No.: US 2011/0231498 A1
(43) Pub. Date: Sep. 22, 2011

(54) Systems and Methods for Transmitting Messages to a User of a Network

(76) Inventor: Tom C. Tovar, San Francisco, CA (US)

(21) Appl. No.: 12/897,670

(22) Filed: Oct. 4, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 15/16

(52) U.S. Cl. 709/206

(57) ABSTRACT

Systems and methods for transmitting messages to a user of a network are provided. A message and a selection of a triggering event may be received by an Internet service, via a user interface between a first end user and the Internet service. A notification including the message may be generated. The notification may be transmitted via both the user interface and the network between the Internet service and a second end user in response to an occurrence of the triggering event. In accordance with various embodiments, the triggering event may include accessing of the Internet by the second end user via the network, or the accessing of a particular website.

### CROSS REFERENCES TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### FIELD OF THE INVENTION

The present invention is generally related to systems and methods regarding messaging, and more particularly to systems and methods for transmitting messages to a user of a network.

### SUMMARY OF THE INVENTION

Various embodiments of the present invention provide methods and systems for transmitting messages to a user of a network. Such methods and systems are powerful tools for communicating to other members of the network in a more personal way.

It will be noted that as used herein the term “Internet content” encompasses any content that may be accessed by an Internet access user device. Internet content includes, but is not limited to, content presented to the user through a user device. The term “web content” is used herein to refer to any content generated by a web browser. A web browser is also referred to herein as an Internet browser, or just browser.

In accordance with some embodiments of the present technology, an exemplary method for transmitting messages to a user of a network includes several steps. A message and a selection of a triggering event are received by an Internet service from a first end user via a user interface between the first end user and the Internet service. Various embodiments of the method include transmitting a notification to the first end user when a second end user has initiated an occurrence of the triggering event.

In accordance with various embodiments, an exemplary system includes a user interface between an end user and an Internet service for message communication. Various embodiments of the method include a processor for executing instructions for receiving, by an Internet service, a message and a selection of a triggering event via a user interface between a first end user and the Internet service. The processor in the exemplary system is also for executing instructions for generating a notification to a first end user when the triggering event has taken place. In accordance with the exemplary system, the processor is also for executing instructions for transmitting the notification to the first end user via both the user interface and the network. The message may be transmitted to a second end user in response to an occurrence of the triggering event. The user interface may operate between end users and an Internet service provider (ISP).

For purposes of this disclosure, the definition of “Internet service provider” will include any service or technology that provides a connection to the Internet. Examples of such technologies include but are not limited to traditional Internet service providers, telecommunications companies, cable operators, mobile operators, network operators and any other provider of wired or wireless access to Internet services. The system may be set up to utilize a Domain Name System (DNS) server or a cloud-based networking system.

Various embodiments comprise a non-transitory computer-readable storage medium having embodied thereon a program, the program executable by a processor in a computing device to perform a method for transmitting messages to a user of a network. Some embodiments of the method include receiving, by an Internet service, a message and a selection of a triggering event via a user interface between a first end user and the Internet service. Upon detection of the triggering event, the message may be delivered to a second end user, and a notification may be delivered to the first end user.

Some embodiments may include one or more policy applications (including, but not limited to, a messaging policy application for transmitting messages to a user of a network) that allow an end user to selectively manage at least a portion of an Internet service received by the end user or any other end users within a network. The policy applications may be discrete applications and may be single purpose applications. The applications may be configured to meet the needs, rules and behaviors desired by the end user. The end user may select one or more policy applications from a selection menu to provide an individualized Internet experience for the end user or their household. The end user selects the policy applications that he/she wants to apply to their Internet service. The selections are made using at least one of the Internet access devices available to the user and the user interface with the Internet Service. The policies contained in the policy applications are applied to the Internet service that is supplied to the end user.

The user interface may be accessed though a gateway available to the end user. Gateways include but are not limited to desktops, PCs, laptops, notebooks, game consoles (e.g., an X-box), music players, tablets, IPods, Smartphones and Internet enabled TVs. The system may also be accessed and controlled through remote control means, such as a Smartphone. A Smartphone may be generally defined as a phone with computing capability. A Smartphone may provide Internet access to an end user.

### BRIEF DESCRIPTION OF THE DRAWINGS

FIG. 1 is a flow chart of an exemplary method for transmitting messages to a user of a network in accordance with various embodiments of the present invention.

FIG. 2 is a block diagram of an exemplary environment for transmitting messages to a user of a network in accordance with various embodiments of the present invention.

FIG. 3 is an exemplary screenshot showing a user interface regarding a messaging policy application for transmitting messages to a user of a network in accordance with various embodiments of the present invention.

FIG. 4 is an exemplary screenshot showing a user interface associated with receiving a message and a selection of a triggering event for policy application for transmitting messages to a user of a network in accordance with various embodiments of the present invention.

FIG. 5 is an exemplary screenshot showing a user interface associated with a notification including a message for policy application for transmitting messages to a user of a network in accordance with various embodiments of the present invention.

FIG. 6 illustrates an exemplary Internet service system, with a DNS server, that may be utilized to support the described systems and methods.

FIG. 7 is a block diagram of an exemplary system for providing direct and variable content control for Internet users in accordance with various embodiments of the present invention.

FIG. 8 is a block diagram of an exemplary system for providing notifications regarding Internet access in accordance with various embodiments of the present invention.

### DETAILED DESCRIPTION

Various embodiments of the present invention provide methods and systems for transmitting messages to a user of a network. A first end user of a network may desire to compose a message to a second end user of the network and have the message sent in response to a selected triggering event. An Internet service may receive the message and a selection of the triggering event via a user interface. In response to an occurrence of the triggering event, a notification that includes the message may be generated and transmitted to the second end user via the user interface and the network. Some embodiments enable the first end user to redirect the web browser used by the second end user on the network to display content on a user device that includes the message.

Generally speaking, an administrator may create and enforce messaging polices for one or more end users that utilize computing devices coupled to an Internet service delivered to a location such as a home, residence or place of business or campus. The term “administrator” may include not only individuals, such as parents, but also any individual creating a mediation policies regarding the Internet service delivered to end users. It will be understood that an administrator may also be an end user, although end users who are not also administrators may not create or apply policies.

It will be further understood that because of the diversity of computing devices that may connect to the Internet service, the policy may be applied to the Internet service rather than requiring the policy to affect each computing device individually, such as a messaging application resident on each computing device. In various exemplary embodiments a policy may also reside as a stand alone application on one or more of the computing devices.

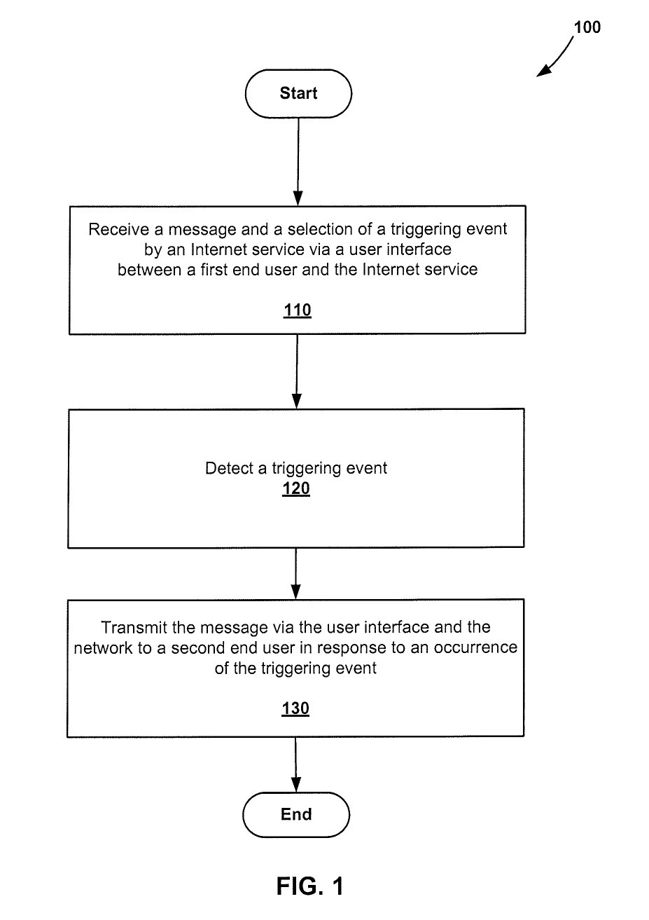

FIG. 1 is a flow chart of an exemplary method 100 for transmitting messages to a user of a network in accordance with various embodiments of the present invention. At step 110 of the method 100, a message and a selection of a triggering event may be received via a user interface between a first end user and the Internet service. The message and the selection may be received by the Internet service.

According to various embodiments, the triggering event may include accessing of the Internet by the second end user via the network. In some embodiments, after the triggering event is activated, the message is sent for display to end users of the network, including the second end user, in response to any end user accessing the Internet via the network.

It may be desired to more clearly target the message to a particular end user. For example, the message may be a personal note from the first end user intended for a particular second end user who is a member of the household using the network to access the Internet. According to various embodiments, this targeting of the message is provided by enabling the first end user to select the triggering event to be information indicative of Internet content of particular interest to the second end user. The first end user may know particular websites or other Internet content that particular users of their network, such as family members, may uniquely access on a regular basis. For example, a child of the first end user may be the only member of the household who accesses particular kid-oriented websites. According to various embodiments, the second end user may select one of the particular kid-oriented websites in order to target the message to the child. Other members of the household who use the network may be targeted similarly, assuming the first end user is aware of their site preferences. The triggering event selected by the first end user may thus be the accessing via the network of Internet content associated with particular Internet information. In some embodiments, the information may be indicative of a domain name of a website. The trigger for initiating the transmitting of the message would then be, for example, the second end user accessing a website associated with the domain name.

In some embodiments, the information supplied by the first end user for the triggering event may be indicative of just a company name. The Internet service may evaluate the supplied company name in order to determine one or more domain names corresponding to the company name. Alternatively, the first end user may supply a domain name or a Uniform Resource Locator (URL) directly, such that the triggering event would respectively be the accessing of a website associated with the domain name or a website URL on the network.

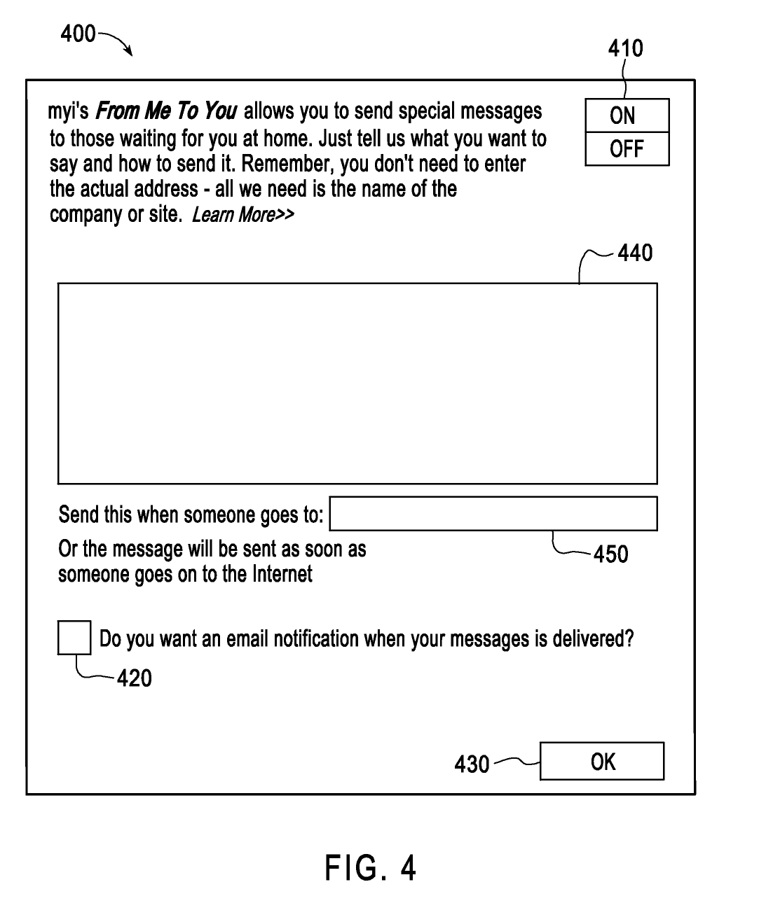

According to various embodiments, the first end user may be away from home and may access the Internet service via the Internet without using the network. The Internet service may provide a form or template on a web page for use by the first end user. The form may have fields in which the first end user may enter the message, indicate the triggering event for transmission of the message, and indicate whether email notification of delivery of the message is desired (see, e.g., the exemplary screenshot 400 in FIG. 4).

At step 120 of the method 100, a triggering event is detected. When detection of the triggering event is confirmed, the message is transmitted, at step 130 of the method 100, via the user interface and the network to a second end user in response to an occurrence of the triggering event. The message may be formatted as an intermediary web page that may be displayed on a web browser. According to various embodiments, transmission of the message may include redirecting a browser activated by the second end user from an activated web page to the intermediary web page. For example, the second end user may be viewing a news article using a browser directed to a particular news website. The browser may have been activated on a device connected to the network that is, in turn, connected to the Internet through use of an Internet service provider. In response to the selected triggering event, e.g., access of the particular news web site, the intermediary web page may be transmitted by the Internet service via the user interface and the network for display on the browser to the second end user, i.e., redirecting the browser to the notification web page. According to various embodiments, the transmitted message page allows the recipient on the network, i.e., the second end user, to choose to return to the previously activated/displayed web page.

In some embodiments, the method 100 includes allowing the receiving second end user to choose to erase, delete or otherwise eliminate the received message. The receiving second end user may also be allowed to choose to disable the transmission of further message notifications.

The method 100 may include processing network information to determine the source of the access of the second end user to the Internet, or a particular web site. In some embodiments, the method 100 may include monitoring whether the second end user is accessing the Internet via a device connected to the network by processing the network information.

The method 100 includes allowing the first end user to indicate that he/she wishes to receive a notification that their message has been transmitted via the user interface and the network to a second end user in response to the triggering event. If the first end user makes this selection, a notification is generated and sent to the first end user when the message has been sent to the second end user.

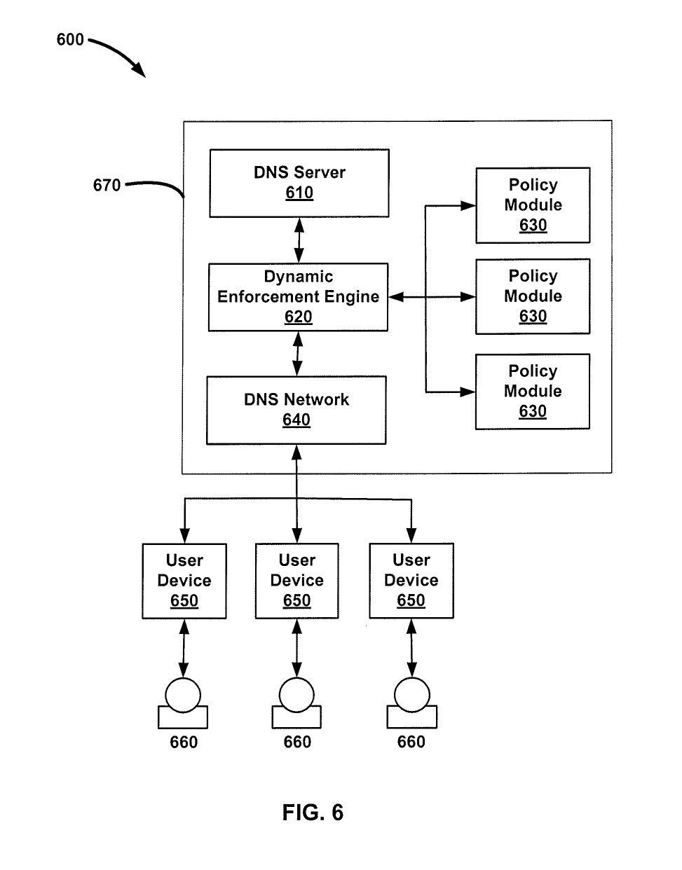

The Internet service may utilize a DNS server (such as the DNS server 610 of FIG. 6). The DNS server may be coupled to the Internet service provider. In accordance with some embodiments, the DNS server may initiate determining whether the selected triggering event has occurred. This may include receiving information from the DNS server regarding which web sites the end users of the network are attempting to access, and determining whether the triggering event has occurred based on the information. For example, the DNS server may provide the Internet service with information that a user on the network is accessing a particular news-oriented Internet site. If this particular new-oriented web site meets the criteria of the triggering event that was selected by the first end user for example, transmission of the notification including the message to the second end user would be triggered.

According to various embodiments, the information regarding Internet content accessed is determined by the Internet service. In some embodiments, the Internet service may be coupled to an Internet service provider. The method typically includes applying policies of a message notification policy application to an Internet service provider to provide notifications, e.g., when certain Internet content is accessed.

In accordance with some embodiments, transmitting the generated notification via a user interface to the second end user further comprises transmitting the generated notification for display for the second end user. The display may typically be a display for a user device (see e.g., the user device 650 in FIG. 6).

The user interface may be accessed though a gateway available to the end user. Gateways include but are not limited to desktops, PCs, laptops, tablets, notebooks, game consoles (e.g., an X-box), music players, tablets, IPods, Smartphones, and Internet enabled TVs.

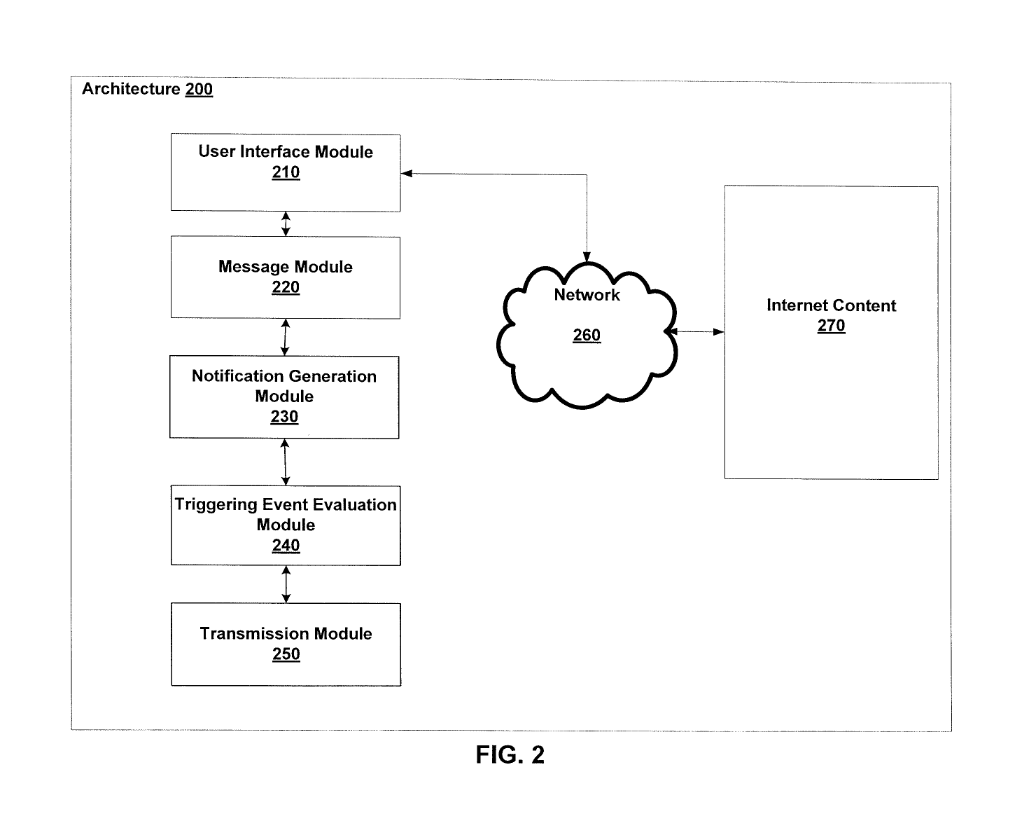

FIG. 2 is a block diagram of an exemplary environment for transmitting messages to a user of a network in accordance with various embodiments of the present invention. More specifically, FIG. 2 illustrates an exemplary architecture 200 of an exemplary system for a messaging policy application, also referred to herein as a message notification policy application. The architecture 200 includes a user interface module 210, a message module 220, a notification generation module 230, a triggering event evaluation module 240, a notification transmission module 250, a network 260, and Internet content 270.

Alternative embodiments may comprise more, less, or functionally equivalent modules. It will be appreciated by one of ordinary skill that examples of non-transitory computer readable storage media may include discs, memory cards, servers and/or computer discs. Instructions may be retrieved and executed by a processor. Some examples of instructions include software, program code, and firmware. Instructions are generally operational when executed by the processor to direct the processor to operate in accord with embodiments of the invention. Although various modules may be configured to perform some or all of the various steps described herein, fewer or more modules may be provided and still fall within the scope of various embodiments.

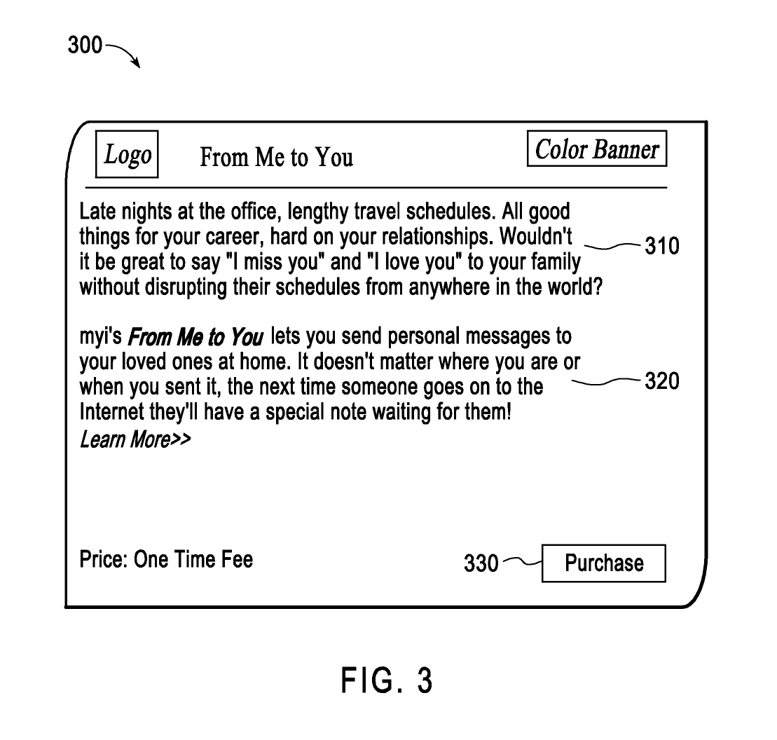

The user interface module 210 provides one or more user interfaces to the first end user as a result of the messaging policy application. The user interface module 210 provides, for instance, a user interface between the first end user and the Internet service to enable the first end user to provide a message and select a triggering event. According to a further instance, the user interface module 210 provides a user interface between an end user of the network, e.g., the second end user, and the Internet service to enable, for example, redirecting the second end user to a web page that includes the notification and the message. Exemplary user interfaces provided by the user interface module 210 are shown in FIGS. 3, 4, and 5.

The message module 220 may perform a step of receiving, by an Internet service, a message and a selection of a triggering event via a user interface between a first end user and the Internet service (such as the step 110 of the method 100 described earlier herein in relation to FIG. 1). The notification generation module 230 may perform a step of generating a notification. The triggering event evaluation module 240 may determine an occurrence of the triggering event (such as the step 130 of the method 100 described earlier herein in relation to FIG. 1). The notification transmission module 250 may perform a step of transmitting the message to a second end user and a notification that the message has been transmitted to the first end user.

The architecture 200 includes a network 260 which may comprise a DNS server. The network 260 may also include any type and number of databases, servers, end users, computing devices, and policy engines. Internet content is shown as Internet content 270.

It will be appreciated by one skilled in the art that the system in FIG. 2 may be merged with or used in conjunction with any of the other exemplary systems described herein, including but not limited to the systems shown in FIGS. 6, 7, and 8. Furthermore, any of the optional steps described in method 100 of FIG. 1 may be performed by or in conjunction with one or more modules depicted in FIG. 2.

FIG. 3 is an exemplary screenshot showing a user interface 300 regarding a messaging policy application for transmitting messages to a user of a network in accordance with various embodiments of the present invention. The exemplary screenshot 300 provides a written summary 310 of the messaging policy application for transmitting a message to a user of a network. The messaging policy application is identified in the exemplary screenshot 300 as “From Me to You.” Such a messaging policy application may implement one or more methods described herein. The first end user may click or otherwise actuate a “Learn More” link 320 which will provide more information about the messaging policy application beyond the initial summary provided to the first end user in user interface 300.

The first end user may select to purchase the messaging policy application by clicking or otherwise actuating the “Purchase” button 330. In some embodiments, the purchase price of the messaging policy application may be a one-time fee, e.g., as indicated in the screen shot in FIG. 3. Further details regarding the one-time fee may be available through actuation of the “Learn More” link 320. Alternatively, the fee may be on a per-use basis. According to various embodiments, following the purchase of the messaging policy application, the messaging policy application is enabled for transmitting messages to users of the network following the purchase of the messaging policy application.

The messaging policy application provides freedom and flexibility for the first end user. According to various embodiments, the first end user may be provided a straightforward opportunity to learn more about the policy application, to setup the message and the triggering event, to request an email notification of delivery of the message, and to enable or disable the messaging policy application

FIG. 4 is an exemplary screenshot showing a user interface 400 associated with a messaging policy application in accordance with various embodiments of the present invention. The user interface 400 may be displayed to a first end user as part of a messaging policy application. The user interface 400 may comprise a configuration drawer. According to various embodiments, a first end user may utilize the user interface 400 to enter a personal message in a field 440 and, optionally, to select a triggering event to enter into a field 450 to configure the messaging policy application. An optional summary of the messaging policy application may be provided in the exemplary user interface 400. The user interface 400 provides an exemplary template for input of the message and configuration settings.

The message entered in field 440 in the example in FIG. 4 may be transmitted in response to the occurrence of a triggering event. According to various embodiments, the default setting for the triggering event is that “the message will be sent as soon as someone goes onto the Internet”, i.e., the message will be sent in response to someone accessing the Internet via a device connected to the network. The first end user may override the default setting by entering information into the field 450. As shown in the screenshot in the example in FIG. 4, the first end user is requested to enter a site name into field 450, and it is indicated that the message will be sent when someone goes to the specified site name. It is assumed that the first end user is aware of the site preferences of the intended recipient, i.e., the second end user.

The first end user may enter the name of a company in field 450, as indicated in the screenshot in FIG. 4. According to various embodiments, the Internet service may evaluate the provided company name and determine one or more corresponding domain names. The accessing of the one or more corresponding domain names on the Internet via the network may then be the selected triggering event for transmitting the message. Alternatively, the first end user may provide a site name, a domain name or a full Uniform Resource Locator (URL), directly, such that the triggering event would be the accessing of the site name, domain name or the full URL on the Internet by the second end user of the network.

The user interface 400 may include an On/Off button set 410 and an OK button 430. According to various embodiments, the functionality of the messaging policy application is automatically enabled in response to the purchase of the application by the first end user. That is, according to various embodiments, the default setting for the messaging policy application, after purchase, is “On.” With the setting set to “On”, a message entered in field 440 may be sent to someone on the network in response to a triggering event, either someone going on the Internet or accessing the web site determined to be associated with the entry in field 450. For example, a first end user may be away from home on travel and wish to send a personal message to their spouse who is known to regularly access a particular sports-oriented website. The first end user may use the Internet service to setup a message to be sent in response to a second end user at home (e.g., the spouse) accessing the particular sports-oriented website, according to this example. The first end user initiating the message need not be away from home to use the Internet service.

In response to activation of the messaging policy application via the “Ok” button 430, the message will be transmitted in response to someone on the network accessing the particular sports-oriented website in this example. In this way, a more personal message can be sent. Optionally, the first end user may let the triggering event for the message remain the default setting, i.e., the accessing of the Internet, in general, rather than the accessing of particular Internet content.

If the first end user wishes to disable the functionality of the messaging policy application, the first end user may click or otherwise actuate the Off button of the On/Off button set 410. Subsequently, if the first end user wishes to re-enable the messaging policy application, the first end user may click or otherwise actuate the On button of the On/Off button set 410. Once the first end user has selected whether to disable or re-enable the messaging policy application, the first end user may click on or otherwise actuate the OK button 430 to have the disable/re-enable choice put into effect. In response to the OK button 420 being selected, the user interface 400 appears to close.

The first end user may also click or otherwise actuate a “Learn More” link which will provide more information about the messaging policy application beyond the initial summary provided to the first end user in the user interface 400.

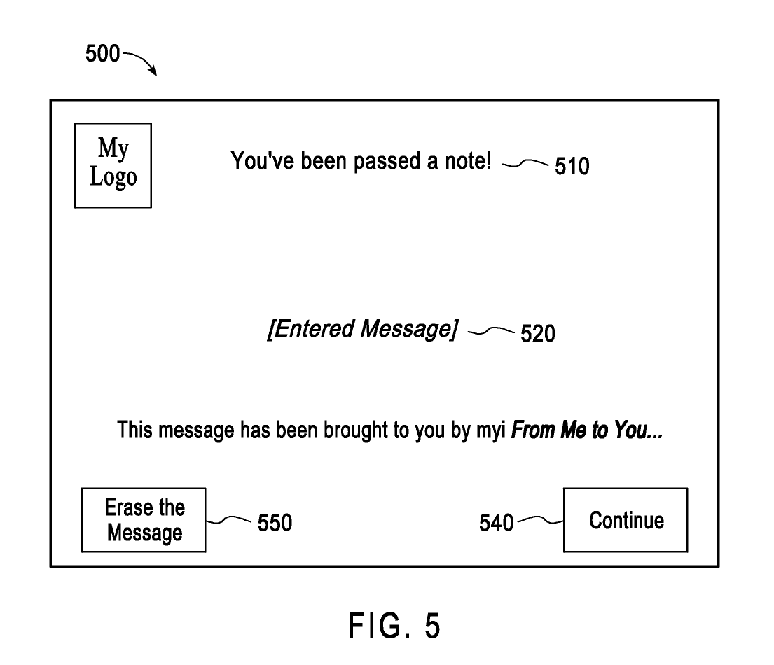

FIG. 5 is an exemplary screenshot showing a user interface 500 associated with a notification of the transmission of a message for the messaging policy application in accordance with various embodiments of the present invention. The user interface 500 may be displayed to an end user as part of a messaging policy application. According to various embodiments, the user interface 500 may be a web page. As shown in FIG. 5, the user interface 500 may include display of a notification summary 510, e.g., “you've been passed a note” followed by the entered message 520. The entered message 520 may correspond to the personal message entered in field 440 in FIG. 4.

According to various embodiments, the notification is formatted as an intermediary web page, such as shown in the screenshot 500. The intermediary web page may be transmitted by redirecting a browser activated by the receiving end user from a currently-activated web page to the intermediary web page. That is, in response to the selected triggering event, e.g., access of a particular web site, the intermediary web page may be transmitted by the Internet service via the user interface and the network for display on the browser to the second end user in place of the currently-activated web page.

According to various embodiments, the recipient end user may reach the Internet content that the recipient end user intended to access. In the example in FIG. 5, the recipient may click or otherwise actuate a “Continue” button 540 in order to access the intended Internet content. In some embodiments, the method 100 includes enabling the second end user to disable the transmission of further message notifications.

An identification 530 of the Internet service which provided the messaging may also included in the notification (see e.g., “myi's From Me to You . . . ” in FIG. 5). The user interface 500 optionally enables the receiving end user to erase the message, e.g., the “Erase the Message” button 550. In response to the receiving end user clicking or otherwise actuating the “Erase the Message” button 550, in this example, the message provided as the entered message 520 is erased.

The systems and methods described above may typically be resident in an Internet service or a DNS network. The systems and methods described may also be implemented in plug-in utilities, gateway devices, cable modems, proxy servers, set top boxes, and network interface devices.

FIG. 6 illustrates an exemplary Internet service system 600, with a DNS server 610, that may be utilized to support the above described systems and methods. The DNS server 610 operates in conjunction with a dynamic enforcement engine 620. The dynamic enforcement engine 620 may operate in conjunction with one or more policy modules 630 to establish any applicable polices at the DNS server 610 level. The content rules are applied to received user queries, and determine the content that is delivered by the DNS network 640 through various user devices 650 to the end users 660.

The dynamic enforcement engine 620 may generate its policy engine on instructions received from one or more policy modules 630. Each policy module 630 may be constructed to provide various types and levels of services to the DNS network 640. In various embodiments, a policy module 630 may be configured to handle queries directed to subjects including, but not limited to, malicious domain redirection, user access redirection, non-existent domain redirection, and data collection or analysis.

It will be recognized by those skilled in the art that the elements of DNS service 670 may be hosted either locally or remotely. In addition to residing in the DNS service 670, one or more of the DNS network 640, the dynamic enforcement engine 620, and the policy modules 630, and any combination thereof, may be resident on one or more user devices 650.

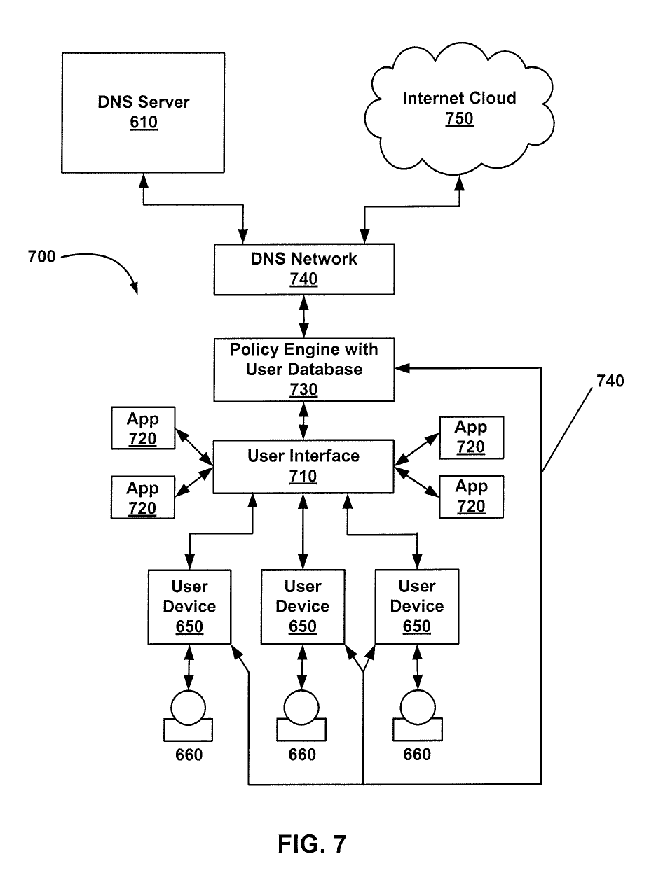

FIG. 7 is a block diagram of an exemplary system 700 for providing direct and variable content control for Internet users in accordance with various embodiments of the present invention. FIG. 7 illustrates that the system 700 may operate installed on a DNS server 610, or with an Internet cloud 750 based installation.

The system 700 utilizes a user interface 710. The user interface 710 may be implemented in many embodiments. One specific implementation of the user interface 710 is as a web page.

The user interface 710 may be accessed by one or more user devices 650 operated by the users 660. The user interface 710 may be accessed though a gateway user device 650 available to the users 660. Suitable user devices 650 include but are not limited to desktops, PCs, laptops, notebooks, gaming devices, IPods, Smartphone, automobile computer systems, and Internet enabled TVs. The system 700 may also be accessed and controlled remotely through user devices 650, such as a Smartphone. A Smartphone may be defined as a phone with computing capability. A Smartphone may provide the user 660 with Internet access. The method 100 may be provided for use with the disclosed systems as an app. As used herein, an app shall be defined as a module including a user interface to an Internet service. The app may further include one or modules included in the Internet service. An app may be downloaded and installed on a user's computing device, including mobile devices. Users may define messaging policy via a user device, such as through the user interface. Some embodiments of the present invention do not require software to be downloaded or installed locally to the user device and, accordingly, do not require the user to execute a de-install application to cease use of the system.

The user interface 710 provides a mechanism for one or more authorized users 660 to establish content policy for the Internet service. The user interface 710 operates between the user devices 650 present in the system 700 and the DNS network 640. Instructions resident on the user interface 710 therefore operate on the Internet service, by controlling at least a portion of DNS resolutions via a dynamic policy engine 730, before the service reaches the displays of the user devices 650.

The user interface 710 provides the users 660 with access to one or more policy applications (“App”) 720. The user interface 710 may provide access to a selection list to at least one authorized user 660. The authorized user 660 uses the selection list or some other menu mechanism to select those policy applications 720 that the user 660 chooses to apply to the system 700. The authorized user 660 may select any number of the available policy applications for use on the system 700 at any given time. In implementations utilizing Smartphones as the user device 650, the policy applications 720 are downloaded to the device 650. The device 650 then serves as the user interface 710 to communicate directly with the dynamic policy engine 730.

The policy applications 720 may prohibit access to specific sites. The policy applications 720 may also limit the time of day when users or selected users 660 may access certain sites. The policy applications 720 may also manage and analyze duration of access to various sites. It is important to note that the policy applications 720 do not simply provide blocking mechanisms by masking or enabling network controls, but rather mediate an Internet service received by the end user. As used herein, mediating the service may include any of blocking, constraining, enabling, redirecting, promoting, demoting, substituting, obscuring, limiting, interrupting, and restricting all or a portion of the Internet service. The policy applications 720 may provide notifications or alerts to one or more users 660 when sites are accessed. The policy applications 720 may also provide notification of frequency and duration of access of designated sites. The policy applications 720 may also be used to observe, substitute, enable, redirect users, to reward behavior desired from the users by a system administrator, etc. The policy applications 720 may redirect users from a non-favored site to another site. The policy applications 720 may also collect and transmit data characteristic of Internet use.

Access policies supplied by the policy applications 720 may apply to all users 750 of the system 700, or the access policies may be specific to individual users or groups of users 750. The policy applications 720 may be discrete, single purpose applications.

The policy applications 720 provide the users 650 with a mechanism to take various actions relative to their Internet service feed. The policy applications 720 also allow the users 650 to establish a dynamic policy engine 730 that includes a user database. The policy engine 730 is used to enforce rules associated with each policy application associated with individual end users, not simply block various inappropriate sites from the Internet feed. Rather, the dynamic policy engine 730, controlled by the user interface 710 through user device(s) 650, is used to manage all aspects of the Internet experience for the users 660. In sum, the policy applications 720 may be used to configure the dynamic policy engine 730 to provide the users 660 with a mechanism to personalize the Internet experience. The policy applications 720 may be configured in combinations, and may each be separately configured.

The database in the policy engine 730 may be used to record and to notify users 660 of various data relative to Internet access. The data collected from and provided to the users 660 may include records of access of specific sites, time spent on specific sites, time of day of access, data specific to individual users, etc.

It should also be noted that following an initial setup through the user interface 710 of the policy engine 730, a direct access 740 enforcement loop may be established between the policy engine 730 and the user devices 650. Subsequent accessing of the DNS network 640 utilizing the direct access 740 decreases response time in the system 700, thereby further enhancing the Internet experience of the users 660. Configurations of policy applications 720 that are selected by one or more users 660 designated as system administrators may remain in the user database of the policy engine 730 until such time as it may be modified by the system administrators. The system administrators may define multiple policy configurations, with a combination of policy applications 720, applicable to one or more end users 660 of the system 700. Each policy application 720 may be separately configurable as well. Policy configurations may vary based upon designated times, conditional triggers, or specific requests from the users 660 with administrative authority.

As indicated above, two discrete data flow paths may be established for the system 700. A first data path establishes a set of enforcement policies for the system 700. The first data path flows from at least one user device 650 through the user interface 710, to the policy engine 730. A second data path, direct access 740, may be utilized following the establishment of a set of policies for the system 700. The second data path, direct access 740, flows directly between the user device(s) 650 and the policy engine 730. Multiple sets of enforcement policies may be established and saved within the system 700 and implemented selectively by the users 660.

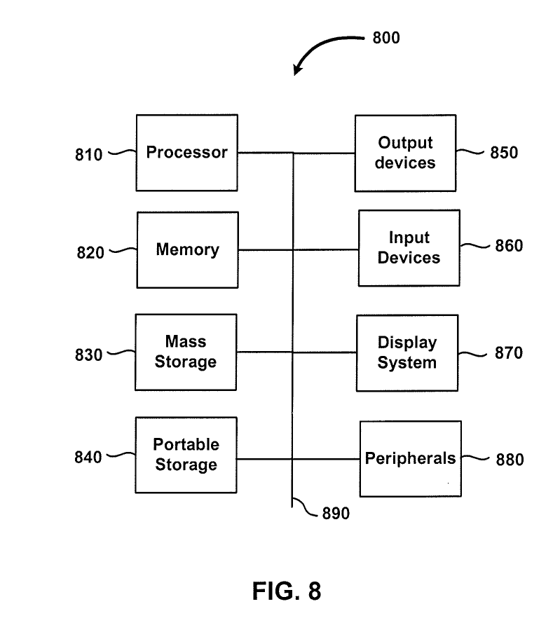

FIG. 8 is a block diagram of an exemplary system 800 for providing notifications regarding Internet access in accordance with various embodiments of the present invention. System 800 of FIG. 8 may be implemented in the context of user devices 650, DNS server 610, Internet cloud 750 and the like. The computing system 800 of FIG. 8 includes one or more processors 810 and memory 820. Main memory 820 stores, in part, instructions and data for execution by processor 810. Main memory 820 can store the executable code when the system 800 is in operation. The system 800 of FIG. 8 may further include a mass storage device 830, portable storage medium drive(s) 840, output devices 850, user input devices 860, a display system 870, and other peripherals 880.

The components shown in FIG. 8 are depicted as being connected via a single bus 890. The components may be connected through one or more data transport means. Processor 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive or an optical disk drive, is a non-volatile storage device for storing data and instructions for use by processor unit 810. Mass storage device 830 can store the system software for implementing embodiments of the present invention for purposes of loading that software into main memory 810.

Portable storage device 840 operates in conjunction with a portable non-volatile storage medium, such as a floppy disk, compact disk or Digital video disc, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, or a pointing device, such as a mouse, a trackball, stylus, or cursor direction keys. Additionally, the system 800 as shown in FIG. 8 includes output devices 850. Suitable output devices include speakers, printers, network interfaces, and monitors.

Display system 870 may include a liquid crystal display (LCD) or other suitable display device. Display system 870 receives textual and graphical information, and processes the information for output to the display device.

Peripherals 880 may include any type of computer support device to add additional functionality to the computer system. Peripheral device(s) 880 may include a modem or a router.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service, and vice versa.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

One skilled in the art will further appreciate that the term “Internet content” comprises one or more of web sites, domains, web pages, web addresses, hyperlinks, URLs, any text, pictures, and/or media (such as video, audio, and any combination of audio and video) provided or displayed on a web page, and any combination thereof.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

What is claimed is:

1. A method for transmitting messages to a user of a network, the method comprising:
creating a message from a first end user directed to a second end user;
receiving via a user interface between the first end user and an Internet service the message and a selection of a triggering event from the first end user;
determining that the triggering event has occurred; and
in response to the triggering event, transmitting the message to the second end user.

2. The method of claim 1, wherein the triggering event is the receipt of an access request by the second end user to gain access to the Internet.

3. The method of claim 1, wherein the first end user specifies a number of times that the Internet system delivers the message to the second end user.

4. The method of claim 1, wherein the Internet system allows access to and modification of the content contained in the message from the first end user.

5. The method of claim 1, wherein the triggering event comprises receiving from the second end user a request to access specified Internet content.

6. The method of claim 1, wherein receiving the selection of the triggering event further comprises receiving from the first end user information indicative of Internet content of particular interest to the second end user.

7. The method of claim 6, further comprising enabling the first end user to specify information, wherein the triggering event comprises accessing of Internet content associated with the received information.

8. The method of claim 6, wherein the information indicative of Internet content is indicative of a domain name of a website.

9. The method of claim 1, wherein the Internet system determines Internet sites that trigger delivery of the message based on category descriptions input from the first end user.

10. The method of claim 6, wherein the information associated with Internet content comprises an Internet site and wherein the triggering event is accessing the Internet site.

11. The method of claim 1, wherein transmitting the message via the user interface to a second end user comprises redirecting a second end user from a requested Internet content to the message.

12. The method of claim 11, wherein the message is transmitted via the user interface and the network for display on the user device of the second end user.

13. The method of claim 12, wherein the message enables the second end user to selectively return to the requested Internet content.

14. The method of claim 1, further comprising processing network information to determine a network from which the second end user is accessing the Internet.

15. The method of claim 1, further comprising monitoring whether the second end user is accessing the Internet via a device connected to the network, the monitoring including processing network information.

16. The method of claim 1, wherein when the second end user receives the message, the first end user receives a notification indicating message delivery.

17. The method of claim 16, further comprising the first end user selectively enabling and disabling transmission of the notification.

18. The method of claim 1, further comprising enabling the second end user to selectively disable transmission of messages from the first end user.

19. The method of claim 1, wherein a DNS server initiates determining whether the triggering event has occurred.

20. The method of claim 1, wherein the Internet service initiates determining whether the triggering event has occurred.

21. The method of claim 1, further comprising receiving from a DNS server information regarding which Internet sites the second end user has attempted to access, and using the received information to determine whether the triggering event has occurred.

22. The method of claim 1, further comprising receiving information from the Internet service regarding which Internet sites the second end user has attempted to access and determining whether the triggering event has occurred as a function of the received information.

23. The method of claim 1, wherein the message includes identification of the first end user and the message is a personal note from the first end user to the second end user.

24. The method of claim 16, wherein the notification is transmitted to the network for display to the second end user.

25. The method of claim 1, wherein the first end user stores multiple messages in the Internet service, the Internet service delivering multiple messages to the second end user.

26. The method of claim 1, wherein a mechanism is provided for the first end user to cancel delivery of an undelivered message to the second end user.

27. The method of claim 1, wherein a message includes any of voice, video, text, images, and files.

28. The method of claim 1, wherein at least one element of the messaging policy is resident on a DNS server.

29. The method of claim 1, wherein at least one element of the messaging policy is enforced by a DNS server.

30. The method of claim 1, wherein the administrator specifies different messaging policies for different locations.

31. The method of claim 1, wherein at least one element of the Internet service is resident on a user device.

32. A system for transmitting messages to a user of a network, the system comprising:
a user interface between a first end user and an Internet service; and
a processor for executing instructions for:
creating a message from a first end user targeted to a second end user;
receiving through an Internet service the message and a selection of a triggering event from the first end user via the user interface;
determining that the triggering event has occurred; and
in response to the occurrence of the triggering event, transmitting the message to the second end user.

33. The system of claim 32, wherein the triggering event comprises receiving from the second end user an access request to specified Internet content.

34. The system of claim 32, wherein the triggering event comprises receiving from the second end user an access request to access the Internet.

35. The system of claim 32, wherein receiving the selection of a triggering event further comprises receiving from the first end user information indicative of Internet content of particular interest to the second end user.

36. The system of claim 32, wherein the processor is further for executing instructions for enabling the first end user to specify information, wherein the triggering event comprises accessing Internet content associated with the specified information.

37. The system of claim 36, wherein the information associated with Internet content is indicative of a domain name of a website.

38. The system of claim 32, wherein the processor is further for executing instructions for receiving input from the first end user indicative of a company name via the user interface.

39. The system of claim 38, wherein the processor is further for executing instructions for evaluating by the Internet service to determine one or more domain names corresponding to the company name.

40. The system of claim 39, wherein the triggering event further includes accessing by the second end user via the network of a website having a name including one of the one or more domain names.

41. The system of claim 36, wherein the information associated with Internet content comprises a website, and wherein the triggering event is accessing the website corresponding to the information.

42. The system of claim 32, wherein the processor is further for executing instructions for processing network information to determine whether the second end user is accessing the Internet from the network.

43. The system of claim 32, wherein the processor is further for executing instructions for monitoring whether the second end user is accessing the Internet via a device connected to the network, the monitoring including processing network information.

44. The system of claim 32, wherein the processor is further for executing instructions for enabling the second end user to selectively disable the transmission of notifications.

45. The system of claim 32, wherein a DNS server initiates determining whether the triggering event has occurred.

46. The system of claim 32, wherein the processor is further for executing instructions for receiving from a DNS server information regarding which web sites the second end user has attempted to access, and determining whether the triggering event has occurred based on the information.

47. The system of claim 32, wherein transmitting the message includes sending a notification to the second end user including identification of the first end user, and wherein the message is a personal note from the first end user to the second end user.

48. The system of claim 47, wherein the notification is transmitted to the network for display to the second end user.

49. The system of claim 32, wherein at least one element of the system is resident on a DNS server.

50. The system of claim 32, wherein at least one step is accomplished by a DNS server.

51. The system of claim 32, wherein at least one element of the Internet service resides on a user device.

52. A non-transitory computer-readable storage medium having embodied thereon a program, the program executable by a processor in a computing device to perform a method for transmitting messages to a user of a network, the method comprising:
receiving, by an Internet service, a message and a selection of a triggering event from a first end user via a user interface between the first end user and the Internet service, the triggering event comprising receiving an access request by the second end user to gain access to the Internet;
generating a notification including the message of the first end user, the notification configured to be transmitted to a second end user via the Internet service;
determining that the triggering event has occurred;
in response to an occurrence of the triggering event, transmitting the notification to the second end user, via both the user interface and the network between the Internet service and the second end user;
receiving user input from the second end user, acknowledging that the second end user received the notification; and
in response to the user input from the second end user, granting the access request received from the second end user.

53. A method for transmitting messages to a user of a network, the method comprising:
creating a message from the first end user directed to the second end user, receiving via the Internet service a message and a selection of a triggering event from a first end user via a user interface between the first end user and the Internet service;
determining via a DNS server that the triggering event has occurred; and
in response to the triggering event, transmitting the message to the second end user.

54. The method of claim 53, wherein the triggering event comprises receiving from the second end user an access request to specified Internet content.

55. The method of claim 53, wherein the triggering event comprises receiving from the second end user an access request to access the Internet.

56. The method of claim 53, wherein the first end user specifies a number of times that the Internet system delivers the message to the second end user.

57. The method of claim 53, wherein the Internet system allows access and modification to the content contained in the message from the first end user.

58. The method of claim 53, wherein the triggering event comprises receiving from the second end user at the DNS server a request to access specified Internet content.

59. The method of claim 53, wherein receiving the selection of the triggering event further comprises receiving from the first end user information indicative of Internet content of particular interest to the second end user.

60. The method of claim 53, further comprising enabling the first end user to specify information, wherein the triggering event comprises accessing of Internet content associated with the received information.

61. The method of claim 60, wherein the information indicative of Internet content is indicative of a domain name of a website.

62. The method of claim 53, wherein the Internet system determines Internet sites that trigger delivery of the message based on category descriptions input from the first end user.

63. The method of claim 60, wherein the information associated with Internet content comprises an Internet site and wherein the triggering event is accessing the Internet site.

64. The method of claim 53, wherein transmitting the message via the user interface to a second end user comprises redirecting via a DNS server the second end user from a requested Internet content to the message.

65. The method of claim 64, wherein the message is formatted as an intermediary page, the intermediary page transmitted via the user interface and the network for display on the user device of the second end user.

66. The method of claim 65, wherein the intermediary page enables the second end user to selectively return to the requested Internet content.

67. The method of claim 53, further comprising processing network information to determine whether the second end user is accessing the Internet from the network.

68. The method of claim 53, further comprising monitoring whether the second end user is accessing the Internet via a device connected to the network, the monitoring including processing network information.

69. The method of claim 53, wherein when the second end user receives the message, the first end user receives a notification indicating message delivery.

70. The method of claim 69, further comprising the first end user selectively enabling and disabling transmission of the notification.

71. The method of claim 53, further comprising enabling the second end user to selectively disable transmission of messages from the first end user.

72. The method of claim 53, wherein the Internet service initiates determining whether the triggering event has occurred.

73. The method of claim 53, further comprising receiving from a DNS server information regarding which Internet sites the second end user has attempted to access, and using the received information to determine whether the triggering event has occurred.

74. The method of claim 53, wherein the message includes identification of the first end user and the message is a personal note from the first end user to the second end user.

75. The method of claim 53, wherein the first end user stores multiple messages in the Internet service, the Internet service delivering multiple messages to the second end user.

76. The method of claim 53, wherein a mechanism is provided for the first end user to cancel delivery of an undelivered message to the second end user.

77. The method of claim 53, wherein a message includes any of voice, video, text, images, and files.

78. The method of claim 53, wherein the administrator specifies different messaging policies for different locations.

79. The method of claim 53, wherein at least one element of the Internet service resides on a user device.

80. A system for transmitting messages to a user of a network, the system comprising:
a user interface between a first end user and a DNS server; and
a processor for executing instructions for:
creating a message from the first end user directed to a second end user;
receiving by the DNS server a selection of a triggering event from the first end user via the user interface;
determining that the triggering event has occurred; and
in response to an occurrence of the triggering event, transmitting the message to the second end user.

81. The system of claim 80, wherein the triggering event comprises receiving an access request to specified Internet content by the second end user.

82. The system of claim 80, wherein receiving selection of a triggering event further comprises receiving from the first end user information indicative of Internet content of particular interest to the second end user.

83. The system of claim 82, wherein the processor is further for executing instructions for enabling the first end user to specify information, wherein the triggering event comprises accessing via the network of Internet content associated with the specified information.

84. The system of claim 82, wherein the information associated with Internet content is indicative of a domain name of a website.

85. The system of claim 80, wherein the processor is further for executing instructions for receiving input from the first end user indicative of a company name via the user interface.

86. The system of claim 85, wherein the processor is further for executing instructions for evaluating by the Internet service to determine one or more domain names corresponding to the company name.

87. The system of claim 86, wherein the triggering event further includes accessing by the second end user via the network of a website having a name including one of the one or more domain names.

88. The system of claim 82, wherein the information associated with Internet content comprises a website, and wherein the triggering event is accessing the website corresponding to the information.

89. The system of claim 80, wherein the processor is further for executing instructions for processing network information to determine whether the second end user is accessing the Internet from the network.

90. The system of claim 80, wherein the processor is further for executing instructions for monitoring whether the second end user is accessing the Internet via a device connected to the network, the monitoring including processing network information.

91. The system of claim 80, wherein the processor is further for executing instructions for enabling the second end user to selectively disable the transmission of further notifications.

92. The system of claim 80, wherein a DNS server initiates determining whether the triggering event has occurred.

93. The system of claim 84, wherein the processor is further for executing instructions for receiving from a DNS server information regarding which web sites the second end user has attempted to access, and determining whether the triggering event has occurred based on the information.

94. The system of claim 80, wherein the notification includes identification of the first end user and the message is a personal note from the first end user to the second end user.

95. The system of claim 80, wherein the notification is transmitted to the network for display to the second end user.
